(19) United States
(12) Patent Application Publication
(10) Pub. No.: US 2015/0375522 A1
(43) Pub. Date: Dec. 31, 2015

(54) SCANNING LIGHT-EMITTING CHIP AND PRINTING HEAD HAVING THEREOF

(71) Applicant: Nisho Image Tech Inc., New Taipei City (TW)

(72) Inventor: Chun-Yi Wu, New Taipei City (TW)

(21) Appl. No.: 14/732,886

(22) Filed: Jun. 8, 2015

(30) Foreign Application Priority Data
Jun. 25, 2014 (TW) 103121843

(51) Int. Cl. B41J 2/45; H05B 33/08

(52) U.S. Cl. CPC B41J 2/45; H05B 33/0806; H05B 33/0842

(57) ABSTRACT

A scanning light-emitting chip and a printing head having one or more scanning light-emitting chips are provided. The scanning light-emitting chip has a shift circuit and a light-emitting circuit. The shift circuit includes shift thyristors, first diodes, a second diode, and shift signal lines. The light-emitting circuit includes light-emitting thyristors and a light-emitting control line. The first diodes are sequentially connected in series, and each first diode is electrically connected between two adjacent shift thyristors. A first end of the second diode is electrically connected to the connection between the first one of the first diode and the corresponding shift thyristor. A second end of the second diode is connected to the light-emitting control line or to ground through the ground resistor. Therefore, fewer control lines may be applied to actuate the shift circuit and to control the light emission of the light-emitting thyristors.

### CROSS-REFERENCES TO RELATED APPLICATIONS

This non-provisional application claims priority under 35 U.S.C. §119(a) on Patent Application No. 103121843 filed in Taiwan, R.O.C. on 2014 Jun. 25, the entire contents of which are hereby incorporated by reference.

### BACKGROUND

1. Technical Field

The instant disclosure relates to a light-emitting chip. In particular, the instant disclosure relates to a scanning light-emitting chip and a printing head having scanning light-emitting chips.

2. Related Art

Copying machines, printers, fax machines, and all-in-one printers utilize the electro-photography as the core technology for printing documents. That is, these devices generate photographic images by changing the distribution of electrostatic charges through light with a certain wavelength.

Please refer to FIG. 1, which provides a schematic view of a typical light-emitting diode (LED) printer for color printing. The light-emitting diode printer 100 has photoconductive drums 110K, 110M, 110C, 110Y (generically called 110), printing heads 120K, 120M, 120C, 120Y (generically called 120), and toner cartridges 130K, 130M, 130C, 130Y (generically called 130), which are corresponding to black, magenta, cyan color, and yellow, respectively. After a charge distributing mechanism is applied to the photoconductive drum 110, a uniform charge layer is formed on the photoconductive drum 110. In a scanning procedure prior to the printing, an exposure procedure is required to make pixels of a pattern in a document to be printed convert into visible bright and dark data. The printing head 120 has a plurality of LEDs arranged in a one dimensional direction. When the light emitted by the LEDs is irradiated onto the photoconductive drum 110, the electric potential of the unexposed area of the photoconductive drum 110 remains unchanged, while the electric potential of the exposed area of the photoconductive drum 110 changes. The change of the electric potential allows the exposed area of the photoconductive drum 110 to absorb the carbon powder with positive or negative charges provided by toner cartridge 130. Therefore, the printing function can be achieved.

FIG. 2 is a schematic view illustrating the sensing of a printer 100. As shown in FIG. 2, the printer 100 includes a photoconductive drum 110, a printing head 120, and a lens 150. The lens 150 is located between the photoconductive drum 110 and the printing head 120. The lens 150 is provided for focusing the light emitted from the printing head 120 onto the photoconductive drum 110 to carry out the aforementioned exposure procedure.

FIG. 3 is a schematic top view of the printing head 120. As shown in FIG. 3, the printing head 120 includes a plurality of light-emitting chips 122 arranged along an axis 140 of the printing head 120. In general, each of the light-emitting chips 122 includes hundreds of light-emitting units (e.g., LEDs) arranged in a row. When the light-emitting chips 122 are arranged along the axis 140, the light-emitting units are also arranged along the axis 140, thereby providing high DPI (Dots per inch) resolution. For example, to achieve a 600 DPI resolution, 600 light-emitting units are linearly and uniformly distributed in the span (or width) of one inch. As shown in FIG. 3, the light-emitting chips 122 are arranged above and below the axis 140 of the printing head 120 in an offset manner.

During the printing and photoconductive procedure, the light-emitting units of two adjacent light-emitting chips 122 would sequentially emit light, from the light-emitting units near to the connecting portion between the light-emitting chips to the light-emitting units located at two distant sides of the light-emitting chips, as shown in FIG. 4. FIG. 4 is a schematic view illustrating the photoconductive scanning procedure of the typical printer 100. However, a vertical distance (generally, 63 μm) is defined between the centers of two adjacent light-emitting chips 122. In the case of each of the light-emitting chips 122 having 256 light-emitting units, a vertical shift by 21 μm would be generated in one light-emitting chip from the first light-emitting unit to the last light-emitting unit after the photoconductive drum 110 corresponding to the light-emitting chip 122 is rotated by a certain time period, named, a scanning time. Therefore, theoretically, when the scanning of the right light-emitting chip 122 in FIG. 4 is delayed by three times of the scanning time, the scanning position of the right light-emitting chip 122 would be corrected to be the same as that of the left light-emitting chip 122. Nevertheless, with the inaccuracy in industrial manufacturing, a vertical distance of 63±10 μm is between the centers of two adjacent light-emitting chips 122, practically. Therefore, the accuracy of the starting time of the scanning of the light-emitting chips 122 has to be improved to prevent the vertical shift upon printing.

### SUMMARY

To address the above issue, the instant disclosure provides a scanning light-emitting chip and a printing head.

In a first embodiment of the instant disclosure, the printing head comprises a plurality of scanning light-emitting chips. The scanning light-emitting chip comprises a shift circuit and a light-emitting circuit. The shift circuit comprises a plurality of shift thyristors, a plurality of first diodes, a second diode, and a plurality of shift signal lines. The shift thyristors are divided into a plurality of groups at intervals. The first diodes are sequentially connected in series, and each of the first diodes is electrically connected between two adjacent shift thyristors. The number of the shift signal lines is equal to that of the groups. The shift signal lines correspond to the groups, respectively. Each of the shift signal lines is electrically connected to the shift thyristors of the corresponding group. The second diode has a first end and a second end. The first end is electrically connected to the connection between the first one of the first diodes and the corresponding shift thyristor. The light-emitting circuit comprises a plurality of light-emitting thyristors and a light-emitting control line. Each of the light-emitting thyristors is electrically connected to a corresponding shift thyristor. The light-emitting emitting control line is electrically connected to each of the light-emitting thyristors and electrically connected to the second end of the second diode. Based on the above, the light-emitting control line can receive a light-emitting control signal to sequentially turn on the shift thyristors of the shift circuit and control, corresponding to the actuated shift thyristors, the light-emitting thyristors of the light-emitting circuit to emit light.

In a second embodiment of the instant disclosure, the printing head comprises a plurality of scanning light-emitting chips. The scanning light-emitting chip comprises a shift circuit and a light-emitting circuit. The shift circuit comprises a plurality of shift thyristors, a plurality of first diodes, a second diode, a plurality of shift signal lines, and a ground resistor. The shift thyristors are divided into a plurality of groups at intervals. The first diodes are sequentially connected in series, and each of the first diodes is electrically connected between two adjacent shift thyristors. The number of the shift signal lines is equal to that of the groups. The shift signal lines correspond to the groups, respectively. Each of the shift signal lines is electrically connected to the shift thyristors of the corresponding group. The second diode has a first end and a second end. The first end is electrically connected to the connection between the first one of the first diodes and the corresponding shift thyristor. One of two ends of the ground resistor is electrically connected to the second end of the second diode, and the other end of the ground resistor is grounded. The light-emitting circuit comprises a plurality of light-emitting thyristors and a light-emitting control line. Each of the light-emitting thyristors is electrically connected to a corresponding shift thyristor. The light-emitting control line is electrically connected to each of the light-emitting thyristors.

According to the scanning light-emitting chip and the printing head of the embodiments of the instant disclosure, the light-emitting thyristors can emit light within certain light-emitting time duration of the light-emitting signal. Therefore, the start time of scanning can be adjusted precisely. In addition, since the time for the light emission of the light-emitting thyristors can be controlled by one light-emitting control line, besides the bonding pads connected to the shift signal lines and the low level line, a bonding pad is further utilized to connect to the light-emitting control line. Therefore, the size of the printing head can be reduced.

Detailed description of the characteristics and the advantages of the disclosure is shown in the following embodiments, the technical content and the implementation of the disclosure should be readily apparent to any person skilled in the art from the detailed description, and the purposes and the advantages of the disclosure should be readily understood by any person skilled in the art with reference to content, claims and drawings in the disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 is a schematic view of a traditional light-emitting diode printer for color printing;

FIG. 2 is a schematic view illustrating the sensing procedure of a traditional printer;

FIG. 3 is a schematic top view of a printing head in the traditional printer;

FIG. 4 is a schematic view illustrating the photoconductive scanning procedure of the traditional printer;

FIG. 5 is a circuit diagram of a scanning light-emitting chip according to a first embodiment of the instant disclosure;

FIG. 6 is a schematic signal diagram of the scanning light-emitting chip according to the first embodiment of the instant disclosure;

FIG. 7 is a schematic top view of a portion of circuit layout of the scanning light-emitting chip according to the first embodiment of the instant disclosure;

FIG. 8 is a schematic top view of a portion of circuit layout of the scanning light-emitting chip according a variation of the first embodiment of the instant disclosure;

FIG. 9 is a schematic diagram of the signal time duration of the shift signal lines and the light-emitting control line of the scanning light-emitting chip according to the first embodiment of the instant disclosure;

FIG. 10 is a circuit diagram of a scanning light-emitting chip according to a second embodiment of the instant disclosure;

FIG. 11 is a schematic signal diagram of the shift signal lines of the scanning light-emitting chip according to the second embodiment of the instant disclosure;

FIG. 12 is a schematic voltage graph of the gate ends of the shift thyristors in the initial time duration;

FIG. 13 is a schematic voltage graph of the gate ends of the shift thyristors in a first light-emitting time duration;

FIG. 14 is a schematic voltage graph of the gate ends of the shift thyristors in a second light-emitting time duration; and

FIG. 15 is a schematic voltage graph of the gate ends of the shift thyristors in a third light-emitting time duration.

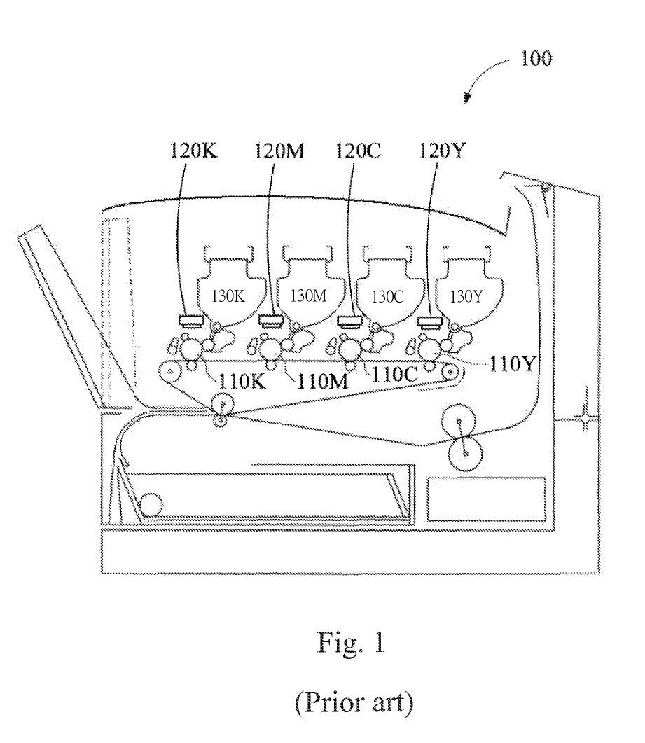

### DETAILED DESCRIPTION

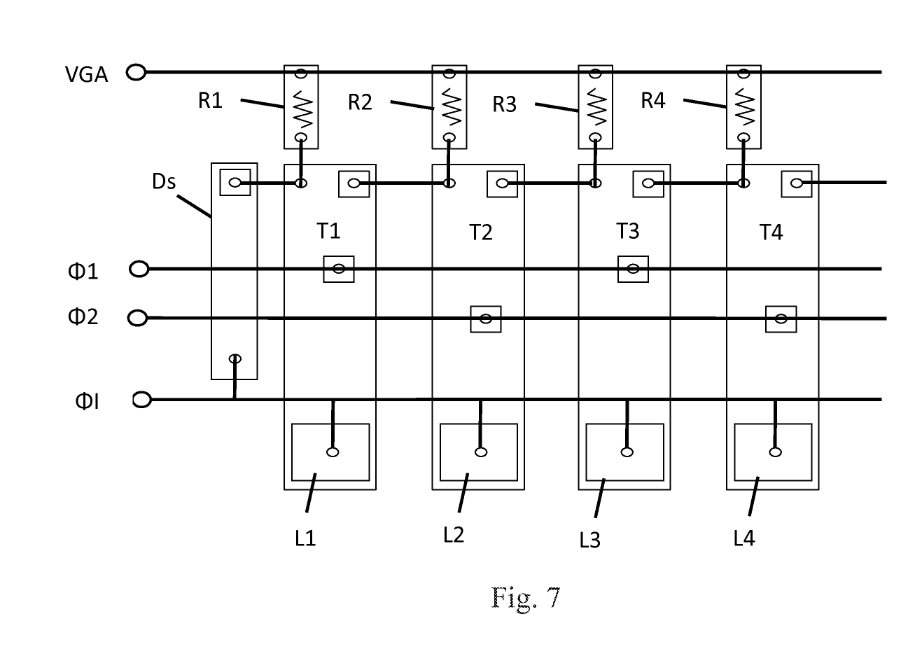

FIG. 5 is a circuit diagram of a scanning light-emitting chip according to a first embodiment of the instant disclosure. FIG. 7 is a schematic top view of a portion of circuit layout of the scanning light-emitting chip according to the first embodiment of the instant disclosure.

As shown in FIG. 5 and FIG. 7, the scanning light-emitting chip comprises a shift circuit 300 and a light-emitting circuit 400. The shift circuit 300 comprises a plurality of shift thyristors T1, T2, T3, T4, and the like (generically called T), a plurality of first diodes D1, D2, D3, D4, and the like (generically called D), a second diode Ds, and a plurality of shift signal lines (hereinafter, two shift signal lines φ1, φ2 are illustrated). The light-emitting circuit 400 comprises a plurality of light-emitting thyristors L1, L2, L3, L4, and the like (generically called L) and a light-emitting control line φI. The shift thyristors T and the light-emitting thyristors L may be semiconductors with PNPN structure. The first diodes D may also be manufactured by semiconductor process.

The shift thyristors T are divided into a plurality of groups at intervals. In this embodiment, the shift thyristors T are divided into two groups. Here, the shift thyristors T with odd ordinal numbers (i.e., T1, T3, and the like) are defined as one group (hereinafter, called the odd group), and the shift thyristors T with even ordinal numbers (i.e., T2, T4, and the like) are defined as the other group (hereinafter, called the even group). Each of the first diodes D is electrically connected between two adjacent shift thyristors T. Each of the shift signal lines is electrically connected to the shift thyristors T belonging to one of the groups. For example, the shift signal line φ1 is electrically connected to the shift thyristors T belonging to the odd group (i.e., the shift signal line φ1 is electrically connected to the shift thyristors T1, T3, and the like), and the shift signal line φ2 is electrically connected to the shift thyristors T belonging to the even group (i.e., the shift signal line φ2 is electrically connected to the shift thyristors T2, T4, and the like). Therefore, the number of the shift signal lines is equal to the number of the groups.

Each of the light-emitting thyristors L is electrically connected to a corresponding shift thyristor T. In other words, the light-emitting thyristor Ln is electrically connected to the shift thyristor Tn, and n is a positive integer (e.g., the light-emitting thyristor L1 is electrically connected to the shift thyristor T1, and the light-emitting thyristor L2 is electrically connected to the shift thyristor T2). The light-emitting control line φI is electrically connected to each of the light-emitting thyristors L.

Each of the shift thyristors T comprises a first anode end 31, a first cathode end 32, and a first gate end 33. Each of the light-emitting thyristors L comprises a second anode end 34, a second cathode end 35, and a second gate end 36. The corresponding shift thyristor T and light-emitting thyristor L are electrically connected with each other via the first gate end 33 and the second gate end 36. Two ends of each of the first diodes D are electrically connected to the first gate ends 33 of two adjacent shift thyristors T, respectively. For example, the anode end of the first diode D1 is electrically connected to the first gate end 33 of the shift thyristor T1, and the cathode end of the first diode D1 is electrically connected to the first gate end 33 of the shift thyristor T2. Each of the shift thyristors T is electrically connected to a corresponding shift signal line (φ1 or φ2) via the cathode end 32 thereof, and the first anode end 31 of each of the shift thyristors T is grounded. Likewise, the second cathode end 35 of each of the light-emitting thyristors L is electrically connected to the light-emitting control line φI, and the second anode end 34 of each of the light-emitting thyristors L is grounded.

The shift circuit 300 further comprises a low level line V_{GA}, a plurality of load resistors R1, R2, R3, R4, and the like (generically called R), and a second diode Ds. The load resistor R and the second diode Ds may be formed by semiconductors. The first gate end 33 of each of the shift thyristors T is electrically connected to one load resistor R (for example, the first gate end 33 of the shift thyristor T1 is electrically connected to the load resistor R1). One of two ends of the load resistor R is electrically connected to the first gate end 33, and the other end of the load resistor R is electrically connected to the low level line V_{GA}. The low level line V_{GA} provides a pulldown voltage level (here, a negative voltage) for the load resistor R, so that a forward bias is formed between the first gate end 33 and the first anode end 31 of an actuating shift thyristor T. The second diode Ds has a first end 37 and a second end 38. The first end 37 of the second diode Ds is electrically connected to the connection between the first one of the first diodes D1 and the corresponding shift thyristor T1. The second end 38 of the second diode Ds is electrically connected to the light-emitting control line φI. Accordingly, the light-emitting control line φI can be utilized to actuate the shift circuit 300 and to control the light-emitting thyristors L to emit light. Here, the first end 37 of the second diode Ds is a cathode end, and the second end 38 of the second diode Ds is an anode end.

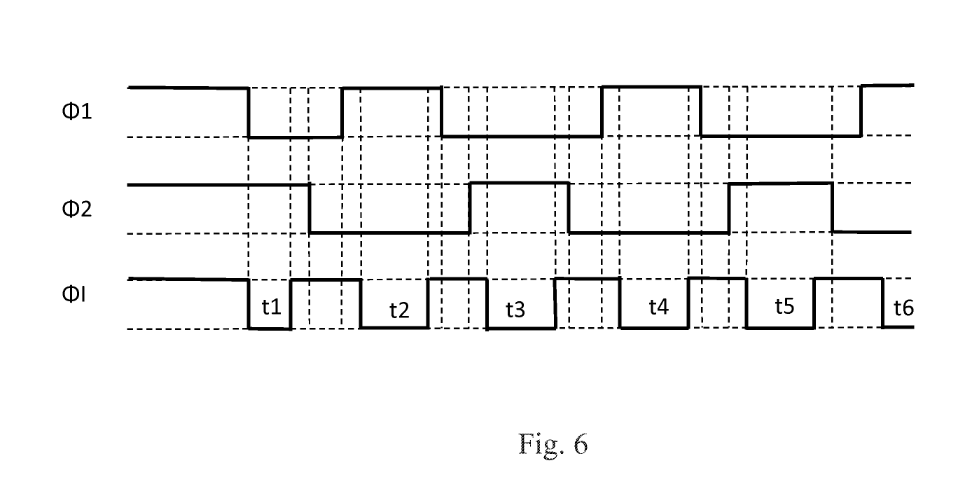

FIG. 6 is a schematic signal diagram of the scanning light-emitting chip according to the first embodiment of the instant disclosure, which schematically shows a timing relation of signals fed by the shift signal lines φ1, φ2 or the light-emitting control line φI.

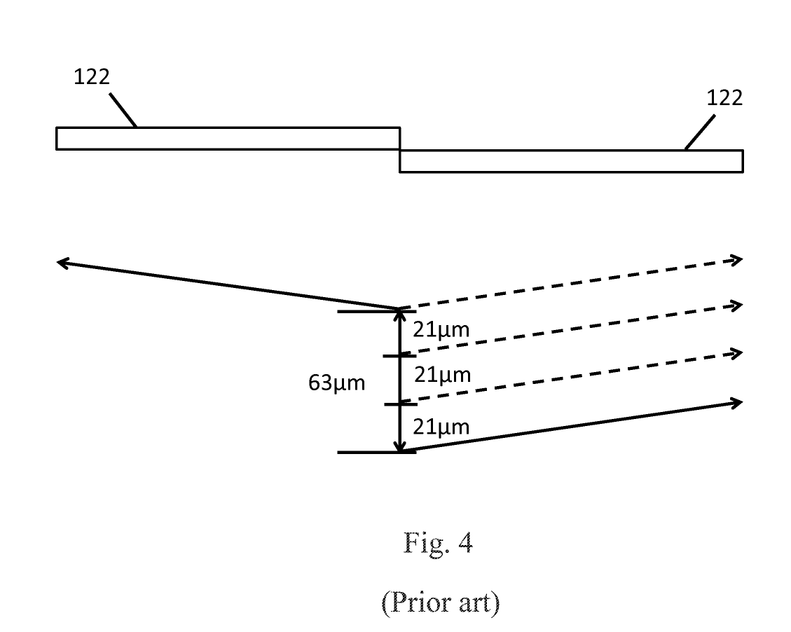

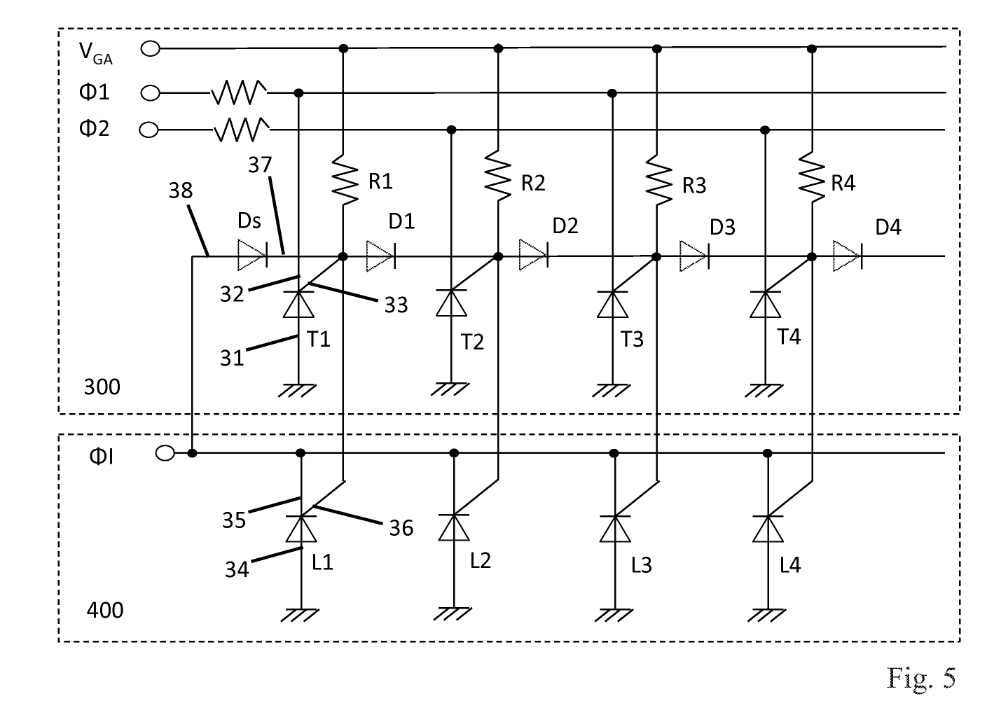

As shown in FIG. 6, two shift signal lines φ1, φ2 individually feed pulse signals with substantially the same pulse width but different phase, wherein the phase difference may be between 90 to 180 degrees. Therefore, in conjunction with the shift circuit 300 shown in FIG. 4, the first anode ends 32 of the thyristors T can be sequentially changed into a low voltage level along a forward conduction direction of the first diodes D when the light-emitting control line φ1 feeds a first pulldown time clock (i.e., in the light-emitting time duration t1). Since the second gate end 36 of the light-emitting thyristor L is electrically connected to the first gate end 33 of the shift thyristor T, the second gate ends 36 of the light-emitting thyristors L are sequentially actuated along with the actuation of the shift thyristor T. When the first anode end 32 of the latter shift thyristor T (or the second anode end 35 of the latter light-emitting thyristor T) has been changed to a low voltage level for a period of time, the first anode end 32 of the former shift thyristor T (or the second anode end 35 of the former light-emitting thyristor T) is restored to a high voltage level. Herein, the high voltage level is a ground level (i.e., 0 volt), and the low voltage level is a negative level (e.g., −5 volt).

The characters of a thyristor such as a shift thyristor T and a light-emitting thyristor L are described as follows. When a forward bias is applied between the anode and the cathode of the thyristor with a breakdown voltage exceeding the PN junction of the thyristor being applied between the gate and the cathode of the thyristor, the thyristor would be conducted. And, after the bias between the gate and the cathode is removed, the thyristor remains in a conducted state until the forward bias between the anode and the cathode is disappeared. Therefore, when the first gate end 33 of the shift thyristor T1 receives a first low level pulse of the shift signal line φ1, so that the shift thyristor T1 is to be actuated, the corresponding light-emitting thyristor L1 is also actuated and emits light due to the corresponding light-emitting thyristor L1 also receives a first low level pulse fed by the light-emitting control line φ1 (i.e., the light-emitting time duration t1). After the first low level pulse of the shift signal line φ1 is over, the light-emitting thyristor L1 continuously emits light until the first low level pulse fed by the light-emitting control line φI is over. Therefore, the light-emitting thyristor L1 can emit light continuously in the light-emitting time duration t1. Likewise, the light-emitting thyristors L2, L3, L4 emit light in the light-emitting time durations t2, t3, t4, respectively.

Herein, although the high voltage level is a ground level (i.e., 0 volt), and the low voltage level is a negative level (e.g., −5 volt), person skilled in the art can exchange the polarities of the elements, and can define the high voltage level as a positive voltage level (e.g., 5 volt), and define the low voltage level as a ground level.

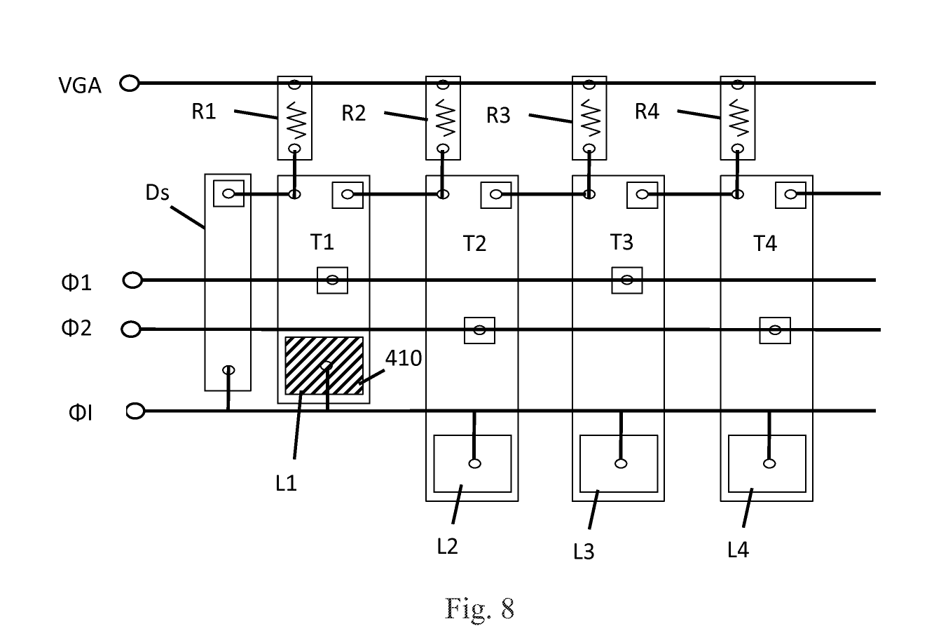

FIG. 8 is a schematic top view of a portion of circuit layout of the scanning light-emitting chip according a variation of the first embodiment of the instant disclosure. As compared with FIG. 7, the first light-emitting thyristor L1 is covered by a shielding plate 410, so that the light emission of the light-emitting thyristor L1 is shielded by the shielding plate 410. Since the light-emitting time duration t1 is the actuating time clock for actuating the shift circuit 300 (i.e., the light-emitting time duration t1 is the first light-emitting time duration when the shift circuit 300 is actuating), the first light-emitting thyristor L1 definitely emits light. In order to perform the selectivity of the exposure procedure, the first light-emitting thyristor L1 is therefore shielded by the shielding plate 410, such that the light emission of the light-emitting thyristor L1 is shielded. Here, the shielding plate 410 is made of aluminum.

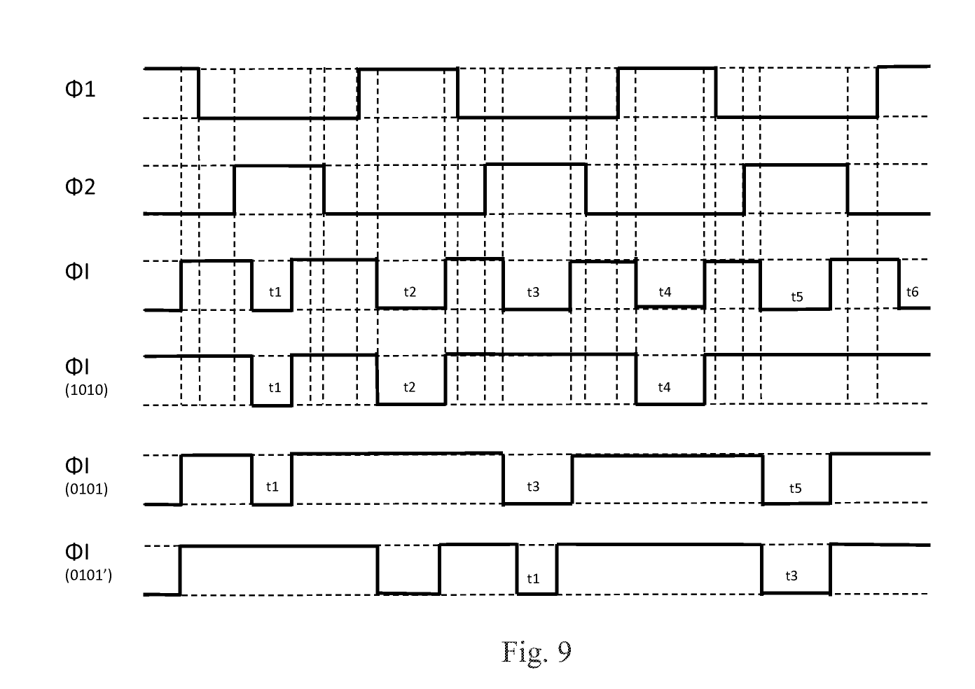

FIG. 9 is a schematic diagram of the signal time duration of the shift signal lines φ1, φ2 and the light-emitting control line φI of the scanning light-emitting chip according to the first embodiment of the instant disclosure. As shown in FIG. 9, the light-emitting control line φI(1010) controls the light-emitting thyristors L1, L2, L4 to emit light sequentially. Since the light-emitting thyristor L1 is shielded by the shielding plate 410, light-emitting thyristors which substantially emit light to the photoconductive drums are the light-emitting thyristors L2, L4. Likewise, the light-emitting control line φI(0101) controls the light-emitting thyristors L3, L5 to substantially emit light to the photoconductive drums. The light-emitting control line φI(0101′) can freely control the light-emitting thyristors L to start emitting light at specific clock time.

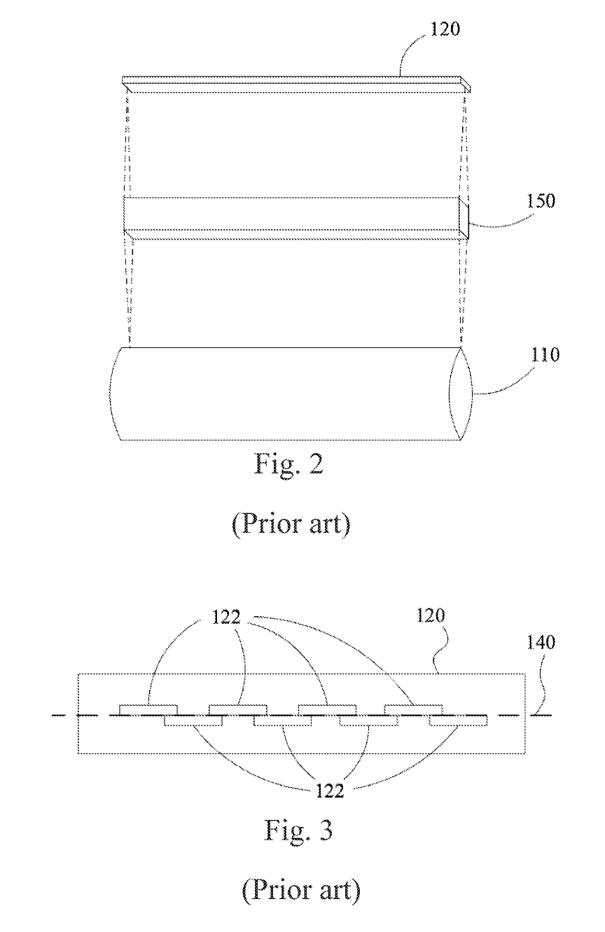

Here, the scanning light-emitting chip is applicable to a printing head. For example, several scanning light-emitting chips may be assembled to a printing head with the similar chip arrangement shown in FIG. 3.

According to the scanning light-emitting chip and the printing head of the first embodiment of the instant disclosure, the light-emitting thyristors can emit light within specific light-emitting time duration of the light-emitting signal. Therefore, the start time of scanning can be adjusted precisely. In addition, since the time for the light emission of the light-emitting thyristors can be controlled by one light-emitting control line, besides the bonding pads connected to the shift signal lines and the low level line, a bonding pad is further utilized to connect to the light-emitting control line. Therefore, the size of the printing head can be reduced.

FIG. 10 is a circuit diagram of a scanning light-emitting chip according to a second embodiment of the instant disclosure. As shown in FIG. 10, the scanning light-emitting chip according to the second embodiment also comprises a shift circuit 300 and a light-emitting circuit 400. As compared with the first embodiment shown in FIG. 5, the shift circuit 300 according to the second embodiment further comprises a ground resistor Rs. One of two ends of the ground resistor Rs is electrically connected to the second end 38 of the second diode Ds, and the other end of the ground resistor Rs is grounded. In this embodiment, the second diode Ds is not required to be connected to the light-emitting control line φ1, thereby simplifying the design of the circuit layout. In addition, the first light-emitting thyristor L1 does not have to be shielded. Two shift signal lines φ1, φ2 and one light-emitting control line φI are sufficient to fine tune the timing when the light-emitting thyristors L start emitting light and to fine tune the light-emitting time duration of each light-emitting thyristor L.

Here, a ratio is defined between the ground resistor Rs and the load resistor R of the shift circuit 300. In other words, the ratio between the resistance value of the ground resistor Rs and the resistance value of the load resistor R is at the range from 0.01 to 1.5. In one embodiment, the ratio between the resistance value of the ground resistor Rs and the resistance value of the load resistor R is at the range from 0.1 to 0.5. Here, the resistance value of the ground resistor Rs may be 1 k ohm, the resistance value of the load resistor R may be 10 k ohm, and the barrier voltage between the first diode D and the second diode Ds is about 1.5 volt.

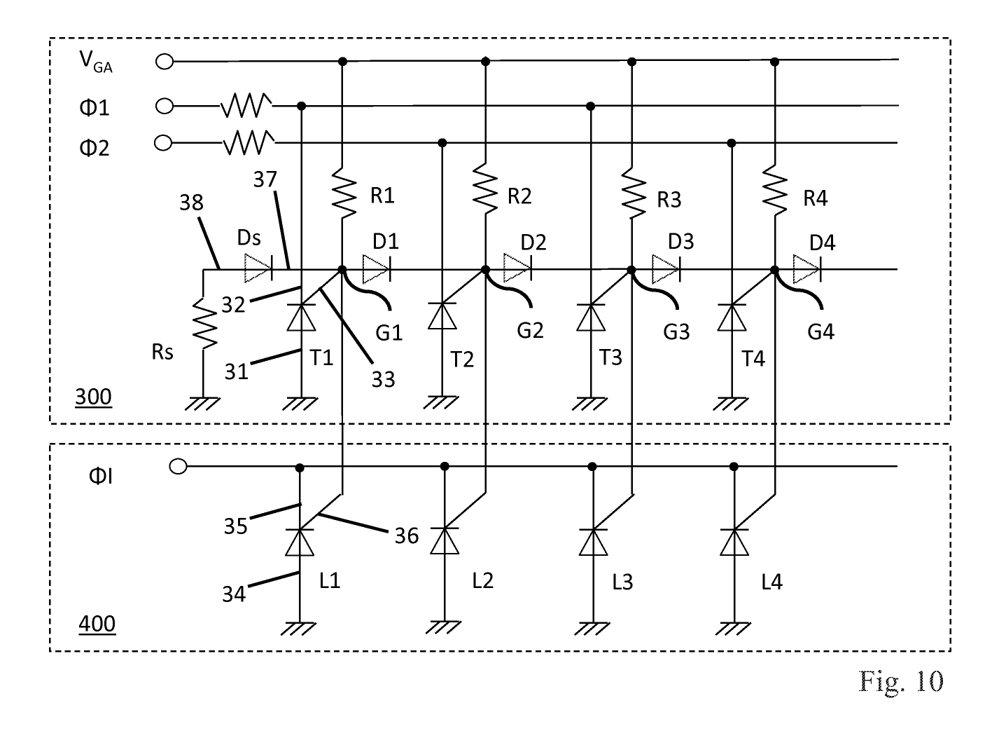

Please refer to FIG. 11, which provides a schematic signal diagram of the shift signal lines φ1, φ2 of the scanning light-emitting chip according to the second embodiment of the instant disclosure. Similar to the first embodiment, the signals of the shift signal lines φ1, φ2 are interleaving with each other. In the initial time duration t0, all the light-emitting thyristors L do not emit light. In the first light-emitting time duration t1, the first light-emitting thyristor L1 emits light, in the second light-emitting time duration t2, the second light-emitting thyristor L2 emits light, in the third light-emitting time duration t3, the third light-emitting thyristor L3 emits light, and so on.

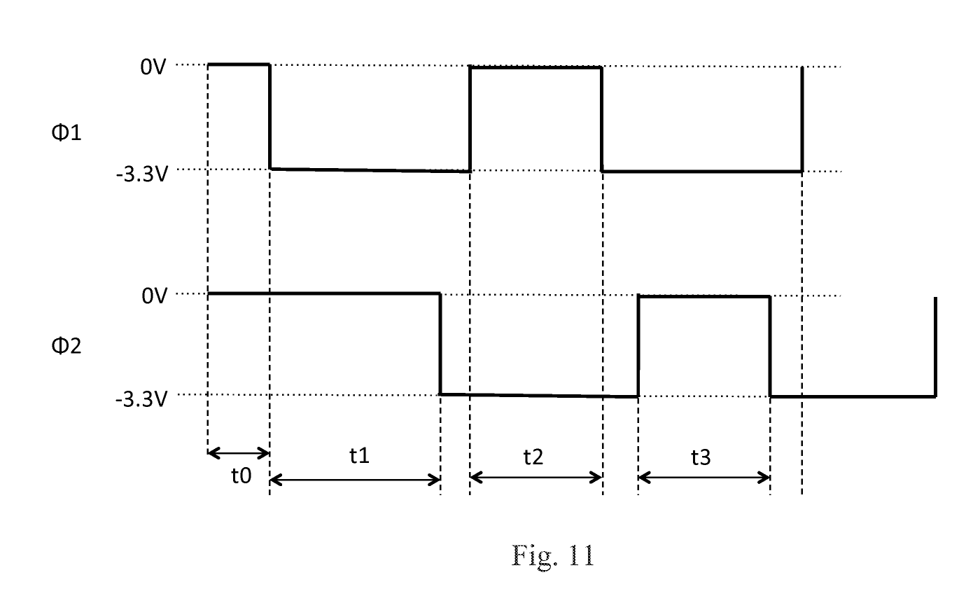

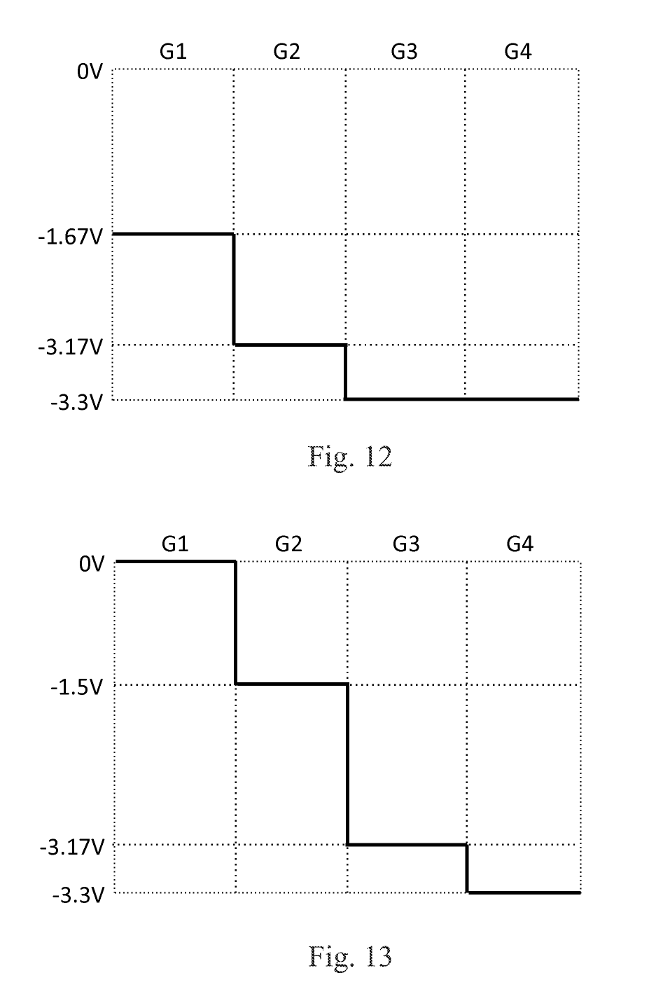

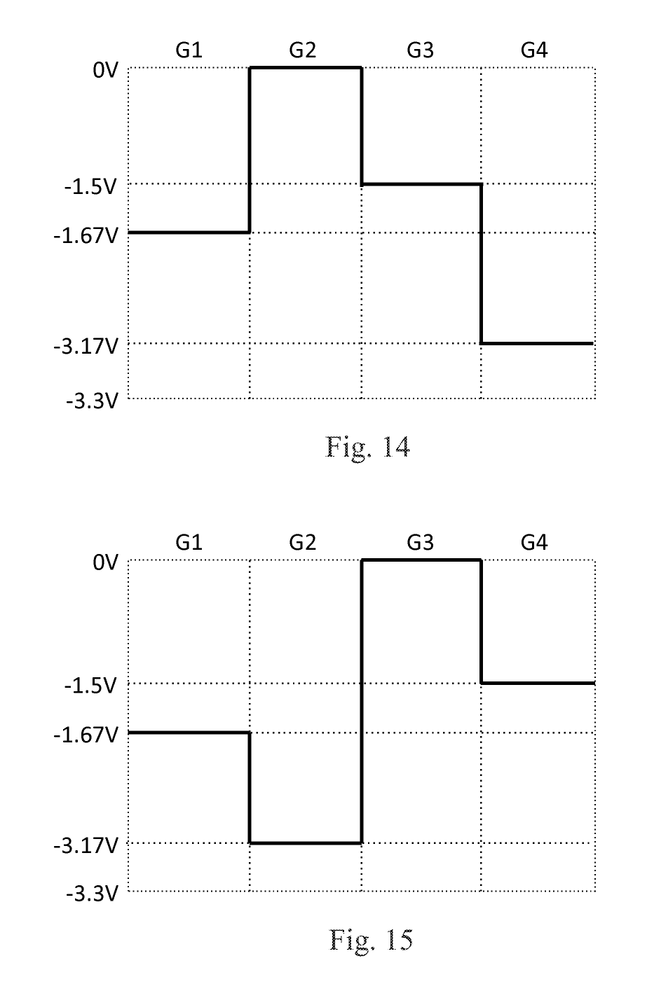

FIG. 12 is a schematic voltage graph of the gate ends of the shift thyristors T in the initial time duration t0. FIG. 13 is a schematic voltage graph of the gate ends of the shift thyristors T in the first light-emitting time duration t1. FIG. 14 is a schematic voltage graph of the gate ends of the shift thyristors T in the second light-emitting time duration t2. FIG. 15 is a schematic voltage graph of the gate ends of the shift thyristors T in the third light-emitting time duration t3. Please refer to FIG. 11 and FIG. 12, in the initial time duration t0, the first shift thyristor T1 is not actuated, and the electric potential of the low level line V_{GA} is about −3.3 volt. Therefore, the electric potential of the gate end G1 of the first shift thyristor T1 is about −1.67 volt. In addition to the barrier voltage of the first diode D1, the electric potential of the gate end G2 of the second shift thyristor T2 is −3.1 volt, and the electric potentials of the gate ends G3, G4 of the other shift thyristors T3, T4 are −3.3 volt.

Please refer to FIG. 11 and FIG. 13, in the light-emitting time duration t1, since the electric potential of the shift signal line φ1 is changed to −3.3 volt, the first shift thyristor T1 is actuated, such that the electric potential of the gate end G1 of the first shift thyristor T1 is 0 volt. Because of the barrier voltage of the first diode D1, the electric potentials of the gate ends G2, G3, G4 of the other shift thyristors T2, T3, T4 are, −1.5 volt, −3.1 volt, and −3.3 volt, respectively.

As shown in FIG. 11, FIG. 13, and FIG. 14, in the light-emitting time duration t1, the electric potential of the gate end G2 of the second shift thyristor T2 is −1.5 volt. In the light-emitting time duration t2, since the electric potential of the shift signal line φ2 is changed to −3.3 volt, the second shift thyristor T2 is actuated, and the electric potential of the gate end G2 of the second shift thyristor T2 is changed to 0 volt. Due to the barrier voltage of the first diode D2, the electric potentials of the gate ends G3, G4 of the shift thyristors T3, T4 are, −1.5 volt and −3.1 volt, respectively. And, the electric potential of the gate end G1 of the first shift thyristor T1 is restored to −1.67 volt.

As shown in FIG. 11, FIG. 14, and FIG. 15, in the light-emitting time duration t2, the electric potential of the gate end G3 of the third shift thyristor G3 is −1.5 volt. In the light-emitting time duration t3, since the electric potential of the shift signal line φ1 is changed to −3.3 volt, the third shift thyristor G3 is actuated, and the electric potential of the gate end G2 of the second shift thyristor T2 is changed to 0 volt. At the same time, since the first shift thyristor T1 is not actuated, the electric potential of the gate end of the first shift thyristor T1 remains −1.67 volt. Likewise, because of the barrier voltage of the first diode D3, the electric potentials of the gate ends G2, G4 of the shift thyristors T2, T4 are, −3.17 volt and −1.5 volt, respectively.

Based on the above, because the ground resistor Rs and the load resistor R may be design to have proper resistance values, the electric potential of the first end 37 of the second diode Ds can be achieved to a value sufficient to actuate the first shift thyristor T in the initial time duration t0. Additionally, with a proper barrier voltage of the first diode D, the electric potential of the gate end 33 of the shift thyristor T next to the actuated shift thyristor T can be maintained to a value sufficient to allow the next shift thyristors T to be actuated. Therefore, the shift thyristors T can be actuated sequentially in responsive to the clock of the shift signal lines φ1, φ2. Here, the electric potential of the first end 37 of the second diode Ds (here, −1.67 volt) is less than the electric potential of the cathode end of the first diode D connected to the actuating shift thyristor T (here, −1.5 volt). In other words, the electric potential of the gate end G1 of the first shift thyristor T1 is less than that of the cathode end of the first diode D connected to the actuating shift thyristor T.

Here, like the foregoing embodiment, the scanning light-emitting chip of the present embodiment of the instant disclosure can be applied to a printing head. For example, several scanning light-emitting chips may be assembled to a printing head with the arrangement of the chips shown in FIG. 3.

While the disclosure has been described by way of examples and in terms of preferred embodiments, it is to be understood that the invention is not limited to the disclosed embodiments. On the contrary, the intent is to cover various modifications and similar arrangements, which are within the spirit and scope of the appended claims, the scope of which should be accorded the broadest interpretation so as to encompass all such modifications and similar structures.

What is claimed is:

1. A scanning light-emitting chip, comprising:
a shift circuit, comprising:
a plurality of shift thyristors divided into a plurality of groups at intervals;
a plurality of first diodes sequentially connected in series, and each of the first diodes is electrically connected between two adjacent shift thyristors;
a plurality of shift signal lines, wherein the number of the shift signal lines is equal to the number of the groups, the shift signal lines correspond to the groups, respectively, and wherein each of the shift signal lines is electrically connected to the shift thyristors of the corresponding group; and
a second diode having a first end and a second end, the first end of the second diode electrically connected to the connection between the first one of the first diodes and the corresponding shift thyristor; and
a light-emitting circuit, comprising:
a plurality of light-emitting thyristors, each of the light-emitting thyristors electrically connected to a corresponding shift thyristor; and
a light-emitting control line electrically connected to each of the light-emitting thyristors and electrically connected to the second end of the second diode.

2. The scanning light-emitting chip according to claim 1, wherein the first end of the second diode is a cathode end and the second end of the second diode is an anode end.

3. The scanning light-emitting chip according to claim 1, wherein the light-emitting circuit further comprises a shielding plate, wherein the shielding plate covers on the light-emitting thyristor, which is adjacent to the second diode.

4. The scanning light-emitting chip according to claim 3, wherein the shielding plate is made of aluminum.

5. A scanning light-emitting chip, comprising:
a shift circuit, comprising:
a plurality of shift thyristors divided into a plurality of groups at intervals;
a plurality of first diodes sequentially connected in series, and each of the first diodes is electrically connected between two adjacent shift thyristors;
a plurality of shift signal lines, wherein the number of the shift signal lines is equal to the number of the groups, the shift signal lines correspond to the groups, respectively, and wherein each of the shift signal lines is electrically connected to the shift thyristors of the corresponding group;
a second diode having a first end and a second end, the first end of the second diode electrically connected to the connection between the first one of the first diodes and the corresponding shift thyristor; and
a ground resistor, one of two ends of the ground resistor electrically connected to the second end of the second diode, and the other end of the ground resistor being grounded; and
a light-emitting circuit, comprising:
a plurality of light-emitting thyristors, each of the light-emitting thyristors electrically connected to a corresponding shift thyristor; and
a light-emitting control line electrically connected to each of the light-emitting thyristors.

6. The scanning light-emitting chip according to claim 5, wherein the shift circuit further comprises a plurality of load resistors, each of the load resistors is electrically connected to the connection between the first diode, the corresponding shift thyristor, and the corresponding light-emitting thyristor.

7. The scanning light-emitting chip according to claim 6, wherein the ratio between the resistance value of the ground resistor and the resistance value of the load resistor is at the range from 0.01 to 1.5.

8. The scanning light-emitting chip according to claim 7, wherein the ratio between the resistance value of the ground resistor and the resistance value of the load resistor is at the range from 0.1 to 0.5.

9. The scanning light-emitting chip according to claim 5, wherein the shift thyristors are actuated sequentially, and the voltage of the first end of the second diode is lower than the voltage of the cathode end of the first diode connected to an actuating shift thyristor.

10. A printing head, comprising a plurality of scanning light-emitting chips, wherein each of the scanning light-emitting chips comprising:
a shift circuit, comprising:
a plurality of shift thyristors divided into a plurality of groups at intervals;
a plurality of first diodes sequentially connected in series, and each of the first diodes is electrically connected between two adjacent shift thyristors;
a plurality of shift signal lines, wherein the number of the shift signal lines is equal to the number of the groups, the shift signal lines correspond to the groups, respectively, and wherein each of the shift signal lines is electrically connected to the shift thyristors of the corresponding group; and
a second diode having a first end and a second end, the first end of the second diode electrically connected to the connection between the first one of the first diodes and the corresponding shift thyristor; and
a light-emitting circuit, comprising:
a plurality of light-emitting thyristors, each of the light-emitting thyristors electrically connected to a corresponding shift thyristor; and
a light-emitting control line electrically connected to each of the light-emitting thyristors and electrically connected to the second end of the second diode.

11. The printing head according to claim 10, wherein the first end of the second diode is a cathode end and the second end of the second diode is an anode end.

12. The printing head according to claim 10, wherein the light-emitting circuit further comprises a shielding plate, wherein the shielding plate covers on the light-emitting thyristor, which is adjacent to the second diode.

13. The printing head according to claim 12, wherein the shielding plate is made of aluminum.

14. A printing head, comprising a plurality of scanning light-emitting chips, wherein each of the scanning light-emitting chips comprising:
a shift circuit, comprising:
a plurality of shift thyristors divided into a plurality of groups at intervals;
a plurality of first diodes sequentially connected in series, and each of the first diodes is electrically connected between two adjacent shift thyristors;
a plurality of shift signal lines, wherein the number of the shift signal lines is equal to the number of the groups, the shift signal lines correspond to the groups, respectively, and wherein each of the shift signal lines is electrically connected to the shift thyristors of the corresponding group;
a second diode having a first end and a second end, the first end of the second diode electrically connected to the connection between the first one of the first diodes and the corresponding shift thyristor; and
a ground resistor, one of two ends of the ground resistor electrically connected to the second end of the second diode, and the other end of the ground resistor being grounded; and
a light-emitting circuit, comprising:
a plurality of light-emitting thyristors, each of the light-emitting thyristors electrically connected to a corresponding shift thyristor; and
a light-emitting control line electrically connected to each of the light-emitting thyristors.

15. The printing head according to claim 14, wherein the shift circuit further comprises a plurality of load resistors, each of the load resistors is electrically connected to the connection between the first diode, the corresponding shift thyristor, and the corresponding light-emitting thyristor.

16. The printing head according to claim 15, wherein the ratio between the resistance value of the ground resistor and the resistance value of the load resistor is at the range from 0.01 to 1.5.

17. The printing head according to claim 16, wherein the ratio between the resistance value of the ground resistor and the resistance value of the load resistor is at the range from 0.1 to 0.5.

18. The printing head according to claim 14, wherein the shift thyristors are actuated sequentially, and the voltage of the first end of the second diode is lower than the voltage of the cathode end of the first diode connected to an actuating shift thyristor.
